(19) United States
(12) Patent Application Publication
(10) Pub. No.: US 2018/0209924 A1
(43) Pub. Date: Jul. 26, 2018

(54) Defect Determining Method and X-Ray Inspection Device

(71) Applicant: Hitachi High-Technologies Corporation, Minato-ku, Tokyo (JP)

(72) Inventors: Hideaki SASAZAWA, Tokyo (JP); Toshiyuki NAKAO, Tokyo (JP); Seiji ISOGAI, Tokyo (JP); Tatsumi HATTORI, Tokyo (JP); Masanobu IEDA, Tokyo (JP); Yasuko AOKI, Tokyo (JP)

(21) Appl. No.: 15/745,851

(22) PCT Filed: Jul. 27, 2015
(86) PCT No.: PCT/JP2015/071182

§ 371 Date: Jan. 18, 2018

(51) Int. Cl. G01N 23/18; G01N 23/04; G01N 23/083

(52) U.S. Cl. CPC G01N 23/18; G01N 23/04; G01N 2223/646; G01N 2223/40; G01N 23/083

(57) ABSTRACT

The present invention provides an X-ray inspection device that detects a defect not on the basis of a change of an X-ray irradiation angle but on uniform determining criteria. As one embodiment for achieving the purpose, proposed below is an X-ray inspection device that is provided with: a detection element that detects a transmission X-ray, which has been emitted from an X-ray source and passed through a sample; and an arithmetic device, which forms a profile on the basis of output signals transmitted from the detection element, and which detects, using the profile, a defect included in the sample. The arithmetic device detects the defect on the basis of threshold setting corresponding to the visual field positions of the transmission X-ray.

### TECHNICAL FIELD

The present invention relates to a defect determining method and an X-ray inspection device, and especially relates to a defect determining method and an X-ray inspection device using which defect determination is executed on the basis of the detection of a transmission X-ray which has passed through a sample.

### BACKGROUND ART

An X-ray inspection device that inspects voids in solder bumps formed on a sample is well known. In Patent Literature 1, an X-ray inspection device that detects voids by irradiating X-rays onto a solder bump is described. Patent Literature 1 discloses a technique in which void candidates are extracted from a profile obtained by irradiating an X-ray onto a bump, and a void is extracted from the void candidates on the basis of a judgment whether each of the void candidates satisfies a predefined criterion or not. In addition, Patent Literature 2 discloses a technology in which a void is detected by irradiating X-rays onto a wafer, in which through-electrodes are formed, obliquely.

### CITATION LIST

### Patent Literature

Patent Literature 1: Japanese Patent No. 45039565

Patent Literature 2: Japanese Unexamined Patent Application Publication No. 2013-130392

### SUMMARY OF INVENTION

### Technical Problem

The miniaturization and high integration of semiconductors have been progressing, and recently a multilayer lamination technology has been evolving significantly as well. The sizes and pitches of solder bumps used in the packaging of semiconductor chips have already been scaled down, and solder bumps the diameters of which are several tens of micrometers to several micrometers have been developed. Furthermore, a TSV (Through Si Via) to penetrate an Si substrate to have the substrate conductive as a technology that satisfies both high-speed transmission and high-density packaging is now deemed to be promising as a next generation semiconductor lamination technology.

In such three-dimensional lamination, although junction is formed using metallic material such as solder, steel, or aluminum, there is a possibility that a defect such as a conduction failure or the like is generated because filling insufficiency, interfusion of air voids, or the like occurs when the junction is formed. In addition, even if there is no problem at an electrical test of a product at the time of manufacturing, it is conceivable that the abovementioned defect will lead to a disconnection during the usage of the product owing to heat, vibration, or the like.

On the other hand, along with the recent further-advanced miniaturization of semiconductors, it is expected that to extract voids from the profiles of the semiconductors becomes more difficult. Furthermore, the fact that, depending on the position of a sample having a bump, a profile that shows the bump provides various shapes has been made apparent by the inventors of the present invention. As a result of keen examination executed by the inventors, it has become clear that such various shapes of the profile corresponding to the same bump are brought about by the change of an X-ray irradiation angle. In Patent Literature 1 or Patent Literature 2, no consideration is paid to the fact that the shape of the profile changes in accordance with such a change of an X-ray irradiation angle.

Hereinafter, a defect determining method and an X-ray inspection device the purpose of which is to detect a defect on the basis of a uniform determining criterion regardless of the change of the X-ray irradiation angle of the X-ray inspection device will be proposed.

### Solution to Problem

As an embodiment for attaining the abovementioned purpose, an X-ray inspection device, which includes: a detection element that detects a transmission X-ray which has been emitted from an X-ray source and passed through a sample; and an arithmetic device that forms a profile on the basis of output signals transmitted from the detection element, and that detects, using the profile, a defect included in the sample, will be proposed hereinafter. In this case, the arithmetic device detects the defect on the basis of threshold settings corresponding to a visual field position of the transmission X-ray.

### Advantageous Effects of Invention

According to the abovementioned configuration, a defect can be detected on the basis of a uniform determining criterion regardless of the irradiation angle of an X-ray.

### BRIEF DESCRIPTION OF DRAWINGS

FIG. 1 is a diagram showing the overview of an X-ray inspection device.

FIG. 2 is a diagram showing the configuration of the X-ray inspection device.

FIG. 3 is a diagram showing an example of a reference sample.

FIG. 4 is a diagram showing signal waveforms obtained when X-rays are irradiated onto a reference sample at the center of the visual field of the X-ray inspection device.

FIG. 5 is a diagram showing signal waveforms obtained when X-rays are irradiated onto the reference sample in a position other than the center of the visual field of the X-ray inspection device.

FIG. 6 is the plan view of an inspection target sample.

FIG. 7 is the cross-sectional view of the inspection target sample.

FIG. 8 is a diagram showing the positional relationship between the positions of bumps on the inspection target sample and detection positions on a detection element.

FIG. 9 is a diagram showing an example of a profile obtained when a solder bump including a void is located in the vicinity of the center of the visual field of the X-ray inspection device.

FIG. 10 is a diagram showing an example of a profile obtained when a solder bump including a void is located in a position other than the center of the visual field of the X-ray inspection device.

FIG. 11 is a flowchart showing a defect inspection process.

FIG. 12 is a diagram showing a profile of a bump including a void.

FIG. 13 is a diagram showing an example in which a peak waveform showing the void is extracted from the profile of the bump including the void.

FIG. 14 is a diagram showing an X-ray inspection device that irradiates an X-ray onto an inspection target obliquely (an oblique angle φ).

FIG. 15 is a diagram showing the positional relationship between the irradiation position of the X-ray and the detection position of a detector.

FIG. 16 is a flowchart showing a process in which evaluation data is collected using a reference sample.

FIG. 17 is a flowchart showing a process in which defect detection is executed using pre-stored evaluation data.

### DESCRIPTION OF EMBODIMENTS

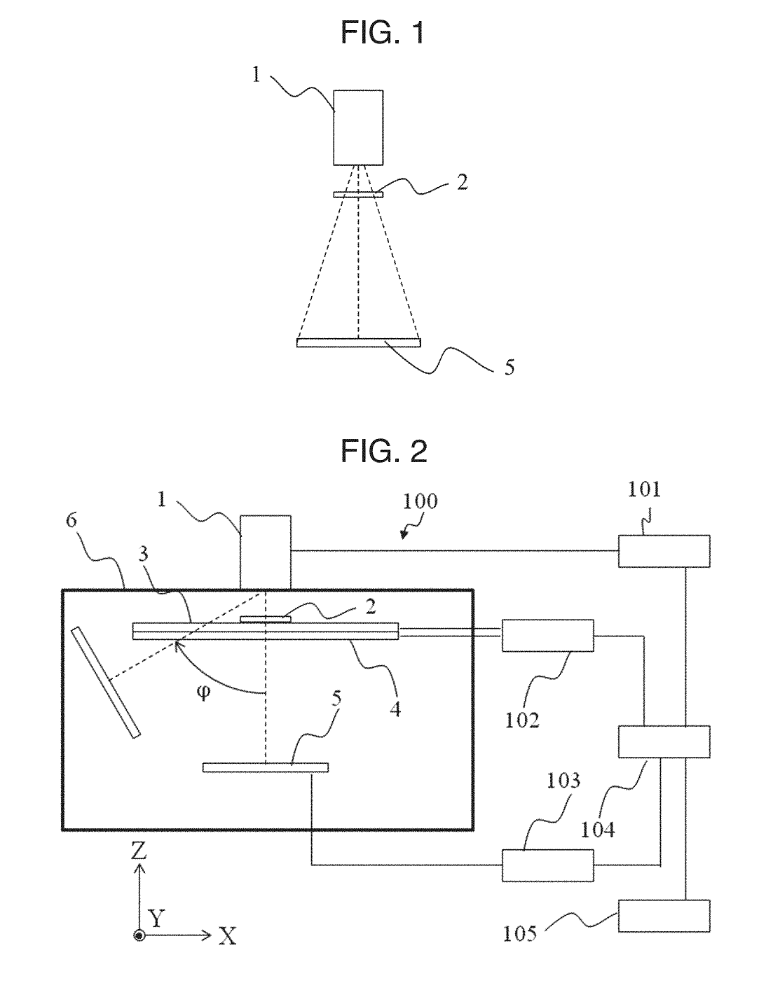

In the inspection of semiconductor bumps in a soldering process which is a post-process of semiconductor manufacturing, it is expected that a high-speed inspection which is performed in conformity to the tact of the relevant manufacturing line is desired. If many inspection targets such as plural bumps, plural TSVs, and the like can be detected within a wide visual field at one time, it is efficient. In an X-ray device, the resolution of the relevant X-ray source is determined by the spot diameter of the X-ray source itself. In the case where detecting a microscopic target relative to the spot diameter of the X-ray source, it will be assumed that a magnifying optical system as shown in FIG. 1 is used. An X-ray inspection device shown in FIG. 1 includes an X-ray source 1, a measurement target 2, and an X-ray detector 5. In this example, the detection visual field over the measurement target 2 is a measurable region that can be measured by the X-ray detector 5, and the magnification ratio of the X-ray inspection device is determined by the ratio of a distance between the X-ray source 1 and the measurement target 2 to a distance between the X-ray source 1 and the X-ray detector 5. In detection using such a magnifying system, an X-ray irradiation angle in the case of the measurement target located at the center of the visual field and an X-ray irradiation angle in the case of the measurement target located at the periphery of the visual field are different from each other. Even if targets are the same, the transmission images of the targets differ from each other when X-ray irradiation angles to the respective targets are different, so that, if a determining criterion using a uniform threshold is applied, defect detection sensitivities for the respective targets become different depending on the detection positions of the respective targets in the visual field.

Hereinafter, an X-ray inspection device including a mechanism, in which an X-ray is irradiated onto an inspection target vertically from above or obliquely from above and the transmission image of the inspection target is detected using an X-ray detector, will be explained. In the X-ray inspection device, a reference sample that includes plural inspection targets having several pre-modeled thicknesses and void defects is used, and the transmission images of the reference sample are detected in the case where the reference sample is disposed in plural positions, irradiation angles corresponding to which are different from each other, in the detection visual field. A luminance attenuation amount caused by an inspection target and a luminance displacement caused by a void defect from the transmission image of the reference sample for each position in the visual field (for each irradiation angle of an X-ray) should be recorded in advance, and evaluation data corresponding to each position in the visual field (corresponding to each irradiation angle of the X-ray) should be created in advance. Alternatively, the reference sample and the transmission image of the reference sample should be obtained by calculation in advance.

In the case of an actual inspection, an X-ray irradiation angle in a visual field is determined from a detection position, and a luminance attenuation amount and an luminance displacement caused by a void defect in the reference sample transmission image corresponding to the X-ray irradiation angle are compared with the luminance displacement position of an inspection target, so that the void defect is detected. The reference sample can be selected from conforming samples and nonconforming samples among the inspection targets.

With the use of the abovementioned configuration, the differences among detection sensitivities caused by differences among X-ray irradiation angles in the detection visual field can be suppressed, and the inspection of an inspection target can be performed using a uniform detection sensitivity.

### Example 1

FIG. 2 is a diagram showing the overview of an X-ray inspection device 100. The X-ray inspection device 100 includes an X-ray source 1, a translation stage 3 for holding a wafer 2 that is a measurement target and moving the wafer 2, a rotation stage 4, an X-ray detector 5, an X-ray shielding wall 6, an X-ray controller 101, a stage controller 102, an X-ray detector controller 103, a control unit 104, and an output unit 105. The X-ray source 1 includes, for example, an electron optical system and a target (not shown).

The electron optical system is, for example, a Schottky electron gun, and is configured in such a way that the target is composed of tungsten thin film and diamond thin film, and the electron optical system irradiates X-rays, which are generated on the basis of the irradiation of electron beams emitted from the electron gun to the target. The translation stage 3 is movable along the X-axis direction, the Y-axis direction, or Z-axis direction, and the rotation stage 4 is rotatable in the XY plane (hereinafter, the rotation direction in the XY plane of the rotation stage is defined as the θ direction). Furthermore, the central part of the translation stage 3 and the central part of the rotation stage 4 are composed of glass (not shown) having a poor X-ray absorption factor. The X-ray detector 5 is disposed opposite to the X-ray source 1 with the translation stage 3 and the rotation stage 4 therebetween. An image intensifier and a CCD camera (a two-dimensional imaging element) are adopted in the X-ray detector of this embodiment.

X-rays irradiated from the X-ray source 1 are absorbed by the wafer 2 disposed on the translation stage 3, and the relevant transmission X-rays are detected by the X-ray detector 5. If it is assumed that a distance between the X-ray detector 5 and the X-ray source 1 is fixed, because the magnification ratio and the size of the visual field of the X-ray-inspection device change in accordance with the change of a relative distance to the wafer 2, these magnification ratio and size of the visual field can be adjusted by adjusting the position of the translation stage 3. The X-ray detector 5 is rotatable in the XZ plane with the X-ray generation position of the X-ray source 1 as its rotation point (the rotation direction in the XZ plane is defined as the φ direction), and the wafer 2 is translated in accordance with the rotation angle of the X-ray detector 5 using the translation stage 3 lest the measurement region should be misaligned. The X-ray source 1, the translation stage 3, the rotation stage 4, and the X-ray detector 5 are disposed inside of the X-ray shielding wall 6 so that X-rays do not leak outside. The X-ray controller 101 controls various parameters of the X-ray source 1 (tube voltage, tube current, magnetic field applied to the electron optical system, barometric pressure, and the like) and ON/OFF of the X-ray generation, the stage controller 102 controls the moving coordinates of the translation stage 3 and the rotation stage 4, and the X-ray detection controller 103 reads data from the X-ray detector 5 and makes settings for imaging conditions (sensitivity, the number of images used for averaging, and the like). The X-ray source controller 101, the stage controller 102, and the X-ray detector controller 103 are controlled by the control unit 104. The X-ray transmission image of the wafer 2 is taken on the basis of inspection conditions input into the control unit 104 in advance via a GUI while the wafer 2 is being moved, defects such as voids are determined on the basis of the obtained transmission image, and the inspection result is displayed on the output unit 105.

An arithmetic device (not shown) is embedded in the controller 104, and it performs after-mentioned arithmetic processing. In an example to be explained hereinafter, an example of an inspection will be explained, in which the X-ray inspection of a reference sample is performed in plural positions in the visual field (X-ray irradiation angles), evaluation data for each position in the visual field is created, and a void inspection corresponding to each position in the visual field is executed using these evaluation data pieces for each position in the visual field.

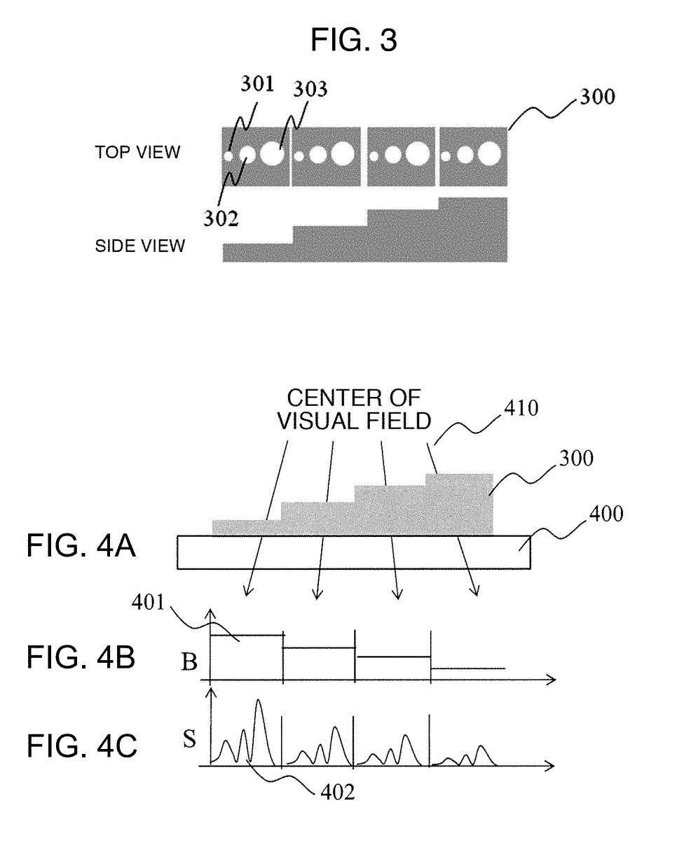

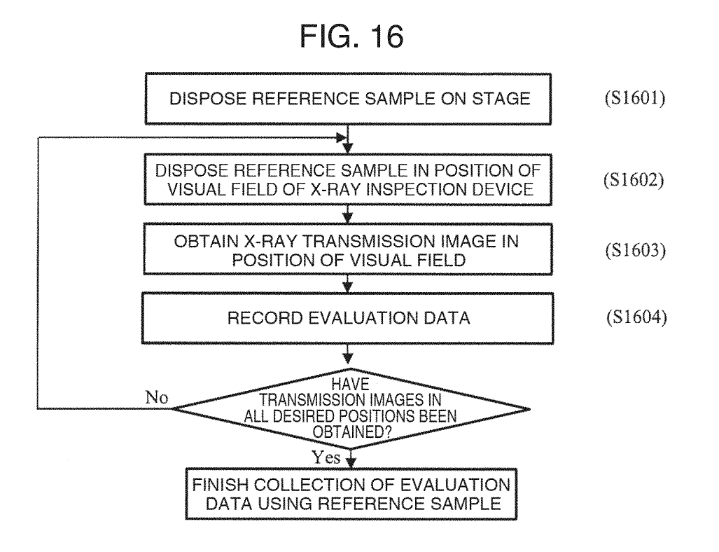

FIG. 3 shows an example of a reference sample 300. FIG. 3 shows the top view and the side view of the reference sample 300, and the reference sample 300 is made of the same material as an actual inspection target is made of. The shape is the shape of a wedge composed of several stairs, and the reference sample 300 is composed of plural regions the thicknesses of which are different from each other. Each region is provided with holes, the sizes of which fall within an assumed range of defective void sizes and different from each other, for example, three types of defective holes 301, 302, and 303. It is not always necessary that the material of the reference sample is the same as that of an inspection target, and if the X-ray absorption factor of the material of the reference sample is known, the X-ray transmission ratio of the material of the reference sample can be converted into the X-ray transmission factor of the material of an actual inspection target. The defective holes are quasi-voids, and the defective holes are formed on or in the reference sample as hemispherical air gaps or spherical air gaps, for example. A process in which evaluation data is created using such a reference sample 300 will be explained with reference to a flowchart shown in FIG. 16.

First, the reference sample 300 is mounted on the translation stage 3 disposed inside of the X-ray shielding wall 6 (Step 1601), and the reference sample is moved to a predefined irradiation angle (to a predefined position in the visual field) (Step 1602). In this example, the reference sample 300 is disposed at the center of the visual field (the center of the X-ray irradiation region) first. By irradiating X-rays onto the reference sample 300 disposed at the center of the visual field, the X-ray transmission image of the reference sample 300 is obtained (Step 1603). FIG. 4(a) is a diagram showing an example obtained by imaging the reference sample 300 mounted on a base substrate 400 such as a Si substrate in the vicinity of the center of the visual field of the X-ray inspection device 100.

In the case where the reference sample is disposed at the center of the visual field, an X-ray flux 410 transmits through the sample uniformly from above, and it is detected by the X-ray sensor 5. FIG. 4(b) is a diagram showing the luminances of X-rays transmitting through the steps of the reference sample 300 and the base substrate 400 for the respective step regions. Generally speaking, because luminance attenuation owing to the transmission of an X-ray is given by I=I₀·exp(−μt), where a detected luminance is represented by I, a light source luminance by I₀, the thickness of a sample by t, and an absorption factor by μ, therefore luminances 401 are determined depending on the thicknesses of the respective step regions. In addition, luminance changes (profiles) from the luminances 401 caused by the void holes 301, 302, and 303 on the reference sample are shown in FIG. 4(c) as luminances 402. In each of the luminances 402, peak luminances corresponding to the void holes in the respective step regions occur. The peak luminances depend on the resolution of the X-ray optical system as well as on the attenuations caused by the transmissions through relevant materials. In such a way, luminances (B) corresponding to the thicknesses of the respective step regions, and the luminance changes (S) caused by the void holes 301, 302, and 303 of the respective step regions are recorded (Step 1604). Furthermore, information about the heights of peaks which should be judged to be corresponding to defects is stored as well. In addition, because the dimensions of the void holes provided to the reference sample are known, information about the dimensions of the void holes is also stored.

Furthermore, in association with the above data, X-ray irradiation angles (or information pieces about the positions in the visual field) when the data are obtained is stored as evaluation data. An X-ray irradiation angle is a relative angle between a line connecting the center of a visual field on a sample with the X-ray source and a line connecting the position of the reference sample with the X-ray source, and additionally storing information about these X-ray irradiation angles makes it possible to read out the evaluation data at the time of inspecting an actual sample. In addition, it is preferable that the evaluation data is stored in association with not the irradiation angles but with distances between the center of the visual field and the positions of the reference sample (information about the positions in the visual field). If the position of the reference sample coincides with the center of the visual field, both X-ray irradiation angle and distance between the center of the visual field and the position of the reference sample become zero.

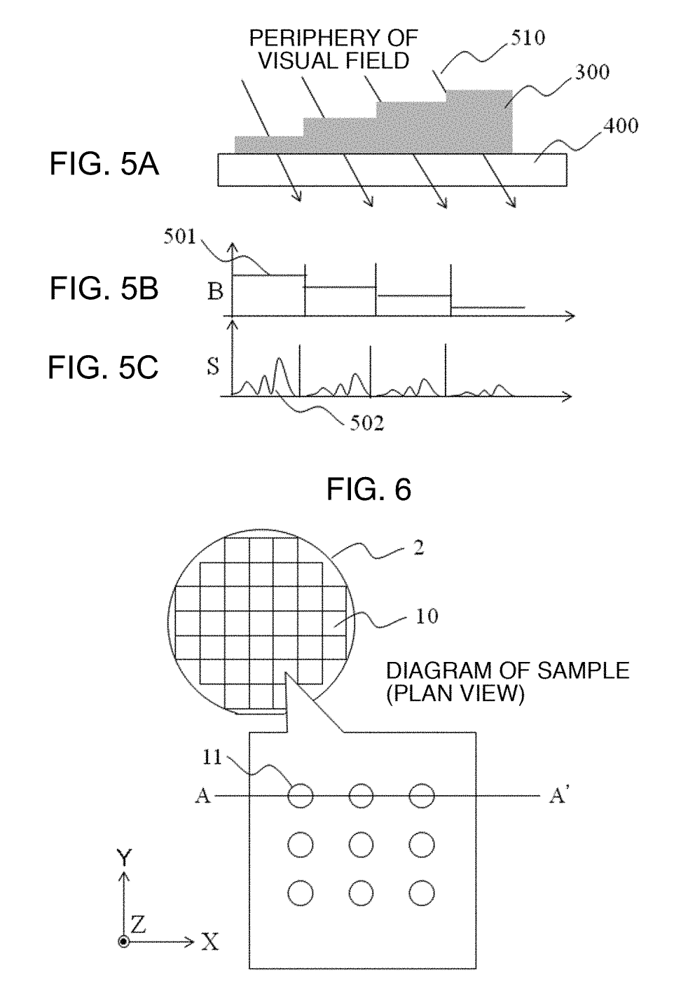

Next, as shown in FIG. 5, the reference sample 300 and the base substrate 400 that are disposed in a position other than the center of the visual field of the X-ray inspection device 100 (represented by “in the periphery of the visual field” in FIG. 5) are imaged. FIG. 5(a) shows the irradiation direction of X-ray flux 510 in the periphery of the visual field, and in such a magnifying transmission system, the X-ray flux 510 is irradiated obliquely. If the position of the reference sample is a position other than the center of the visual field, because the irradiation angle of the X-ray flux is different from that in the case of the X-ray flux 410 being at the center of the visual field, a distance through which each X-ray transmits becomes longer. Therefore, X-ray luminances 501 that transmit through the respective steps of the reference sample 300 and the base substrate 400 and that are shown in FIG. 5(b) and luminance changes 502 that are caused by the void holes 301, 302, and 303 on the reference sample and that are shown in FIG. 5(c) are respectively different. As described above, the luminance values (B) corresponding to the respective steps of the sample and the luminance peak values (S) corresponding to the void holes 301, 302, and 303 in the case of the reference sample located at the center of the visual field and in the case of the reference sample located in the periphery of the visual field are recorded. It is also conceivable that similar recording of data in the case of the reference sample located in any intermediate point in the visual field is executed.

Here, in the case where the abovementioned recordings are executed, it is not always necessary that the reference sample is actually fabricated and detected, and data used for the recordings can be calculated using the specification of the X-ray inspection device 100.

As described above, evaluation data is obtained using the reference sample in at least one position among the center of the visual field and positions other than the center of the visual position. As is explained later, the evaluation data is used when void detection is executed on the basis of a uniform determining criterion regardless of the X-ray irradiation angle by correcting the change of the signal waveform of a bump that changes in accordance with the X-ray irradiation angle. The larger the number angles for obtaining evaluation data is, the more the improvement of the correction accuracy can be expected, therefore it is preferable that the evaluation data is obtained using as many X-ray irradiation angles (many positions in the visual field) as needed, and the evaluation data is stored in a memory medium or the like.

As mentioned above, because void detection on the basis of a uniform evaluation criterion cannot be executed when X-rays are irradiated onto the reference sample in positions in a visual field with various X-ray irradiation angles, the evaluation data are obtained in association with plural X-ray irradiation angles. However, it is also conceivable that the signal waveform of a bump changes not only depending on the irradiation angle but also depending on the irradiation direction. In other word, it is considered that the signal waveform changes depending on the irradiation direction even if the irradiation angle is the same. In such a case, it is conceivable that evaluation data is obtained for plural combinations of irradiation angles and irradiation directions. For example, it is conceivable that evaluation data is obtained in the respective positions (x₁, y₁) to (xₘ, yₙ) in the X-ray irradiation region. Furthermore, although, in the above example, the explanation has been made in such a way that a reference sample is moved to the respective positions (positioned to different positions) in each of which evaluation data is to be obtained, it is conceivable that all the evaluation data are obtained in plural positions using plural reference samples 300 disposed on a line segment or in a matrix on the base substrate 400 without moving a sample. In addition, because evaluation data in each position of the detection element also changes depending on the magnification ratio of the device (the position of the translation stage 3), it is preferable that evaluation data is stored for each device condition.

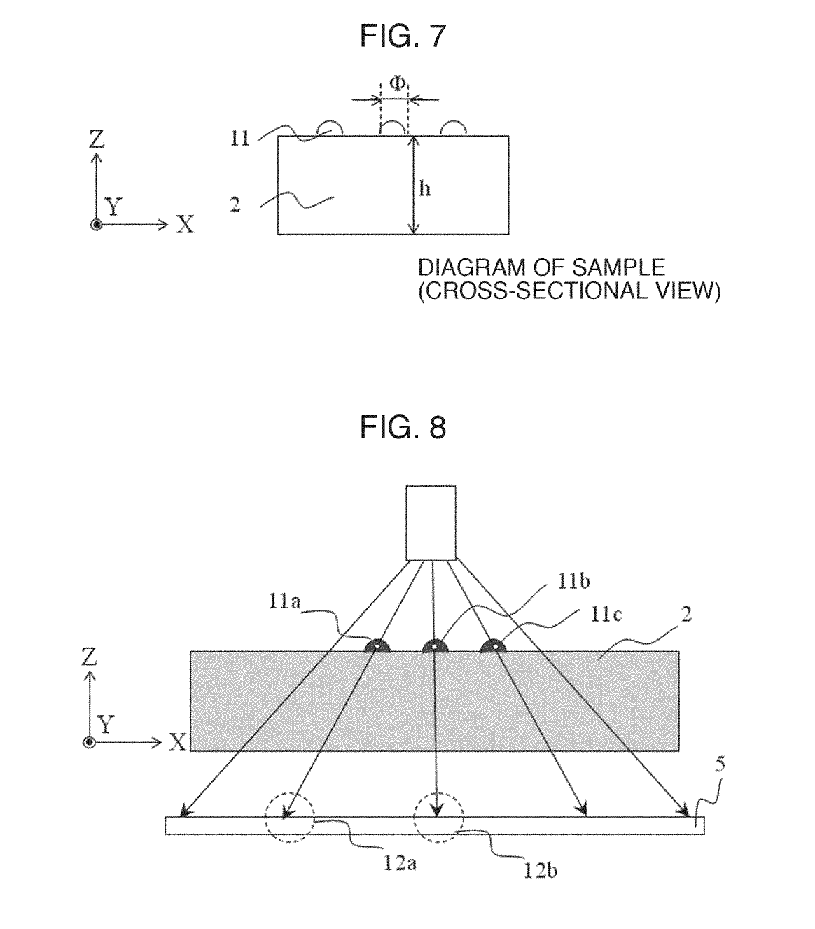

Next, an inspection method in which an actual inspection target is inspected using the evaluation data obtained in the abovementioned way, and an X-ray inspection device using which the inspection is performed will be explained with reference to the accompanying drawings. FIG. 6 is a plan view showing examples of semiconductor bumps 11 formed in a die 10 on the semiconductor wafer 2. FIG. 7 shows the cross-sectional view taken along the line A-A′ of FIG. 6. Plural dice 10 are formed in order on the wafer 2, and solder bumps 11 are formed on some dice 10. FIG. 7 is a diagram showing the bumps 11 formed on the Si wafer 2 the thickness of which is h in such a way that the cross-sectional surface of the Si wafer 2 is viewed squarely.

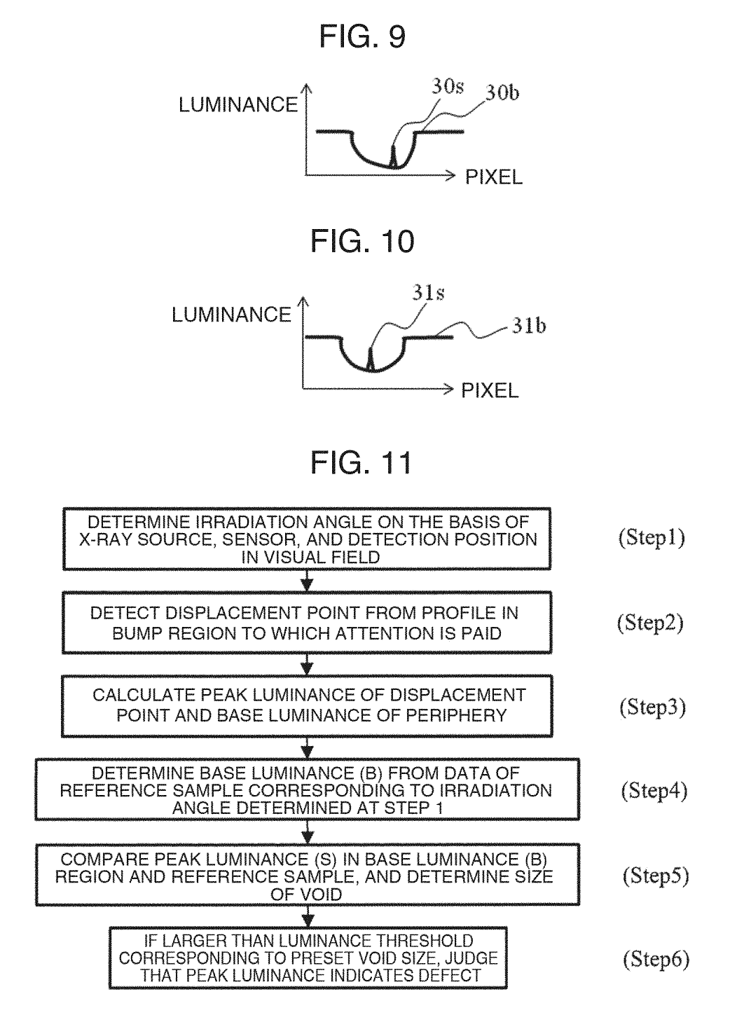

FIG. 8 is a diagram showing a situation where X-rays are irradiated onto solder bumps 11a, 11b, and 11c on a Si wafer 2 and the relevant transmission X-rays are detected by a two-dimensional sensor (an X-ray detector 5). The semiconductor bumps 11a, 11b, 11c are projected onto the visual field, and the semiconductor bump 11a is detected in the detection region (position) 12a of the X-ray detector 5, and the semiconductor bump 11b is detected in the detection region (position) 12b. In the following description, it will be assumed that the region 12b is located at the center of the visual field, and the region 12a is located in a position other than the center of the visual field. FIG. 9 illustrates a luminance profile obtained in the detection region 12a as an example, and FIG. 10 illustrates a luminance profile obtained in the detection region 12b as an example.

If a void is included in the bump 11a (11b), as illustrated in FIG. 9 (FIG. 10), a waveform, which is obtained by superimposing a luminance profile 30s (31s) corresponding to the void on a luminance profile 30b (31b) formed in accordance with the bump 11a (11b), is detected. A process in which whether there is a defect in a void (a bump) or not is judged on the basis of such a detected waveform will be explained with reference to FIG. 11 to FIG. 13.

First, at Step 1, an irradiation angle of an X-ray is determined on the basis of the relative positional relation between the X-ray source of the device and the sensor and a detection position in the visual field of the sensor. With this, result data (evaluation data) corresponding to an irradiation angle near to the determined irradiation angle can be selected among result data obtained using a reference sample in FIG. 4 and FIG. 5. In this case, the result data is read out from the evaluation data stored in advance in a memory medium or the like using the obtained irradiation angle and the position in the visual field.

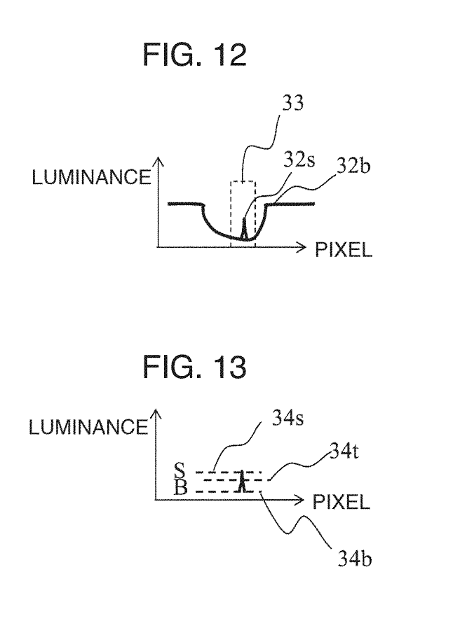

At Step 2, a variant point is detected from a profile in a bump region to which attention is paid. FIG. 12 shows the profile 32b of a detected bump image. By sequentially scanning microscopic change search regions 33 in the profile, a variant point 32s is detected from a profile change ratio, a variance value, or the like in the region.

At Step 3, the peak luminance of the variant point and the base luminance of the periphery are calculated. FIG. 13 shows an example in which only the singular point 32s is extracted, and the peak luminance 34s and the base luminance 34b of the periphery are calculated.

At Step 4, a base luminance of a reference sample that is near to the base luminance 34b is determined from data of a reference sample corresponding to the irradiation angle determined at Step 1.

At Step 5, a peak luminance in the base luminance region of the determined reference sample is compared with the peak luminance 34s, and the size of a void corresponding to the peak luminance 34s is determined. Here, in the comparison with the reference sample in Step 4 and Step 5, it is not always indispensable to select a reference sample the luminance of which is near, and the size of a void corresponding to the peak luminance 34s can be determined by interpolating luminance data of plural reference samples the luminances of which are adjacent to the base luminance 34b.

At Step 6, if the peak luminance 34s is higher than a peak luminance threshold 34t corresponding to a preset void size, it is judged that the peak luminance 34s is a void (or a void that cause a defect).

By recording the detection values of bumps and voids of the reference sample in the visual field in advance and comparing the detection values with those of an actual inspection target, it becomes possible to steadily make void defect determination regardless of the X-ray irradiation angle in the visual field. In addition, although explanations have mainly been made under the assumption that X-ray irradiation angles, detection positions, and luminance profiles are one-dimensional quantities for simplicity in the above embodiment so far, it goes without saying that, if a two-dimensional detector is used as the X-ray detector 5, two-dimensional processing can be performed.

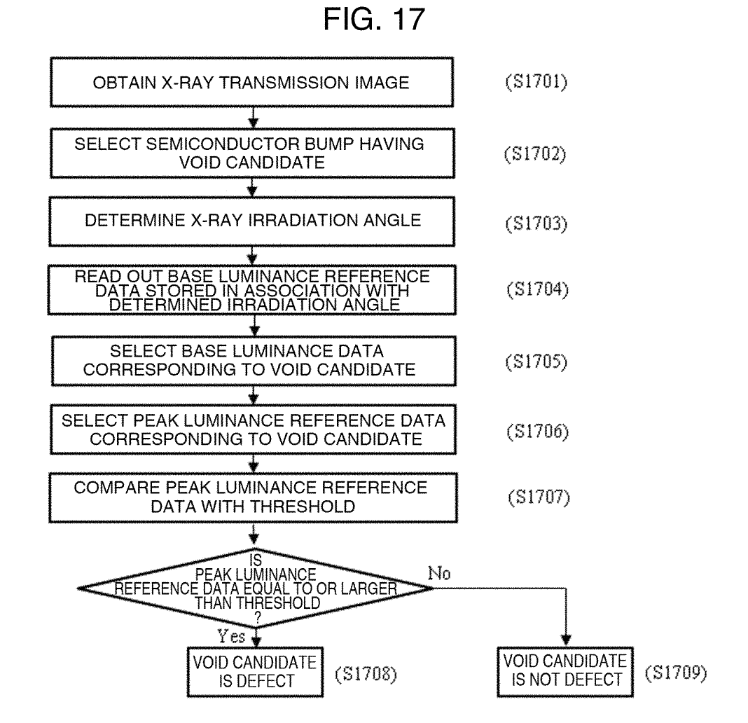

FIG. 17 is a flowchart showing a more concrete bump determining process. First, by irradiating an X-ray onto a semiconductor wafer that includes bumps and that is an inspection target, the X-ray transmission image of the semiconductor wafer is obtained (Step 1701). Next, with reference to a profile showing bumps included in the X-ray transmission image, a bump having a peak corresponding to a void is selected (Step 1702). A void candidate is selected through threshold judgment or the like. On the basis of such a bump selection, an X-ray irradiation angle (a position in the relevant visual field) is determined (Step 1703). Because the position of the bump on the relevant sensor can be determined on the basis of the bump selection, the X-ray irradiation angle is determined on the basis of the specified positional information.

Next, base luminance reference data (evaluation data) stored in association with the determined irradiation angle is readout from the memory medium (Step 1704). In the memory medium, reference data regarding plural base luminances obtained in the positions of different heights of the reference sample (luminances B); reference data of the peak luminances of holes of different sizes for different base luminances (luminance changes (S)); and threshold information used for judging whether a detected peak luminance is a void that is a defect or not are stored for the respective irradiation angles or for plural base luminance reference data pieces which are registered for the respective irradiation angles. Here, if there is no evaluation data of the determined irradiation angle corresponding to the selected bump position, the reference data of the base luminance of an irradiation angle nearest to the determined irradiation angle can be read out and used. Alternatively, it is conceivable that reference data regarding the base luminance of the irradiation angle of the selected bump is calculated using an approximating curve created on the basis of the interpolation or extrapolation of the base luminance reference data (criterial luminance reference data) of two or more irradiation angles adjacent to the determined irradiation angle.

Next, after the base luminance of the selected bump and the read-out reference data of the plural base luminance data pieces corresponding to the different heights are compared, base luminance reference data that is equal to or nearest to the base luminance of the selected bump is selected (Step 1705). Because plural peak luminances corresponding to the sizes of plural voids are stored in association with the selected base luminance reference data, by comparing the plural peak luminance reference data with the void candidate peak, peak luminance reference data that is equal to or near to the void candidate peak is selected (Step 1706). Through such comparison, it becomes possible to specify the size of the void candidate. Here, it is also conceivable that the magnitude of a void candidate is quantified with the use of an approximating curve obtained by interpolating or extrapolating plural peak luminance reference data.

The peak luminance reference data selected as above or the quantified void candidate peak is compared with threshold information registered for the respective base luminance reference data (Step 1707), and if the void candidate peak is equal to or larger than the threshold, the void candidate peak is judged to be a defect void (Step 1708). If a void candidate peak is equal to or smaller than the threshold, the void candidate is judged to be not a defect (or not a defect candidate) (Step 1709).

By making the judgment using the abovementioned algorithm, it becomes possible to identify a defect on the basis of a steady determining criterion regardless of the change of the X-ray irradiation angle. In addition, by respectively registering different thresholds for the plural base reference data pieces registered for the respective irradiation angles, it becomes possible to make defect determination on the basis of a uniform evaluation criterion in a visual field regardless of the change of the distance of an X-ray transmission through a sample. Here, because a void candidate peak and reference peaks regarding plural voids of known dimensions are compared according to the algorithm illustrated as an example in FIG. 17, it becomes possible to specify the size of the void. However, if it is necessary to only judge whether the void is a defect or not, it is conceivable that only defect determination is made using thresholds registered for the respective base luminance reference data without comparing between peaks. In addition, if high accuracy for the defect determination is not needed, after thresholds for making defect determination for the respective irradiation angles are stored in advance, the defect determination can be made only by comparing the void candidate peak with the thresholds.

### Example 2

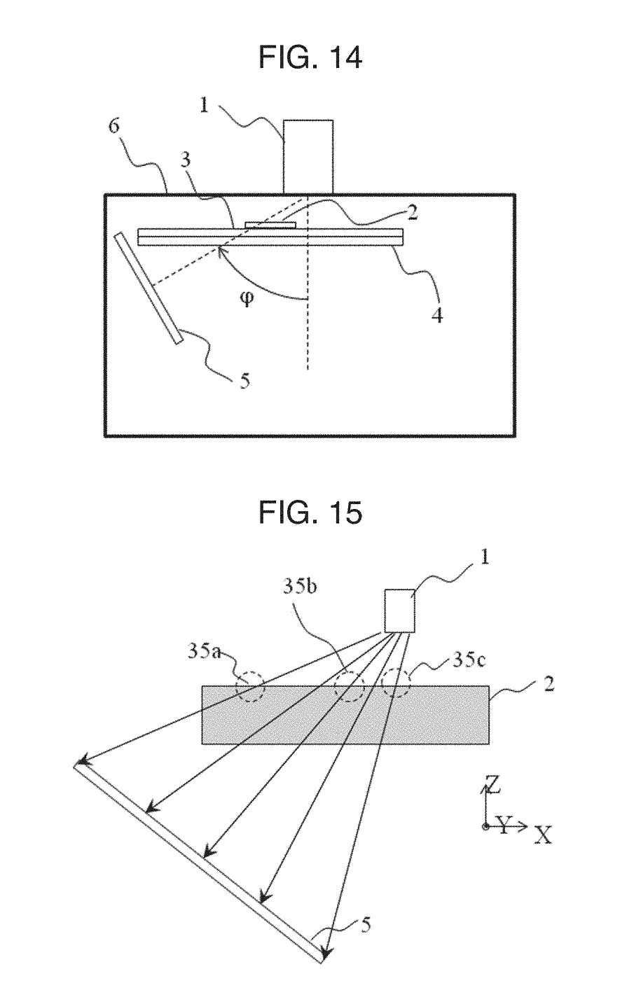

Next, an example of an inspection in which an inspection target 2 is inspected by transmitting obliquely will be explained with reference to FIG. 14 and FIG. 15. FIG. 14 shows an example in which the inspection target 2 is detected by transmitting the inspection target 2 obliquely with an oblique angle φ by moving the translation stage 3 and the X-ray detector 5 of an X-ray inspection device 100. FIG. 15 shows the relationship between X-ray radiations from an X-ray source 1 and the inspection target 2 in a detection region which is covered by an X-ray detector 5. As shown in FIG. 5, it will be understood that, even in such an oblique detection, the irradiation angles are different from each other in the detection region. Also in this case, reference samples 300 are disposed in different positions 35a, 35b, and 35c in the inspection region instead of the inspection target 2, and detected data in the inspection region is recorded. In the case where an inspection target 2 is inspected with an oblique angle φ, by comparing the inspection result of the inspection target 2 with the results of the reference samples as is the case with Example 1, it becomes possible to steadily make void defect determination even in the oblique detection.

As described above, although the reference samples 300 have been used in the above embodiments, if conforming samples and nonconforming samples can be prepared in advance, it is conceivable that, after storing data obtained by X-ray radiations with various radiation angles performed onto those conforming samples and nonconforming samples in a detection region, defect determination is made by comparing the above data with data obtained regarding an inspection target. In this case, by using results obtained through three-dimensional analysis performed by CT in order to confirm void shapes in the conforming samples and nonconforming samples used as reference samples, it becomes possible to make high-precision determination as is the case with the usage of reference samples the dimensions of which are known.

As described above, although the invention achieved by the inventors has been concretely explained on the basis of the embodiments, the present invention is not limited to these embodiments, and it goes without saying that various changes can be made within the scope of the gist of the present invention.

### LIST OF REFERENCE SIGNS

1: X-ray Source, 2: Wafer, 3: Translation Stage, 4: Rotation Stage, 5: X-ray Detector, 6: X-ray Shielding Wall, 10: Die, 11: Bump, 11a: Bump in Periphery of Visual Field, 11b: Bump At Center of Visual Field, 11c: Bump in Periphery of Visual Field, 12a: Detection Region of Bump 11a, 12b: Detection Region of Bump 11b, 30b: Luminance Profile of Bump, 30s: Luminance Change Caused By Void, 31b: Luminance Profile of Bump, 31s: Luminance Change Caused By Void, 32b: Luminance Profile of Bump, 32s: Luminance Change Caused By Void, 33: Microscopic Change Search Region, 34s: Peak Luminance, 34b: Base Luminance of Periphery, 34t: Peak Luminance Threshold, 35a: Position of Visual Field Periphery at the Time of Oblique Detection, 35b: Position of Center of Visual Field at the Time of Oblique Detection, 35c: Another Position of Visual Field Periphery at the Time of Oblique Detection, 100: X-ray Inspection Device, 101: X-ray Source Controller, 102: Stage Controller, 103: X-ray Detector Controller, 104: Control Unit, 105: Output Unit, 300: Reference Sample, 301: Defective Void Hole 1, 302: Defective Void Hole 2, 303: Defective Void Hole 3, 400: Base Substrate, 401: Luminance Determined Depending On Thickness of Step Region, 402: Luminance Change Caused By Void Hole, 410: X-ray Flux, 501: Luminance Determined Depending On Thickness of Step Region, 502: Luminance Change Caused by Void Hole, 510: X-ray Flux

1. An X-ray inspection device comprising: a detection element that detects a transmission X-ray which has been emitted from an X-ray source and passed through a sample; and an arithmetic device that forms a profile on the basis of output signals transmitted from the detection element, and that detects, using the profile, a defect included in the sample,
wherein the arithmetic device detects the defect on the basis of a threshold setting corresponding to a visual field position of the transmission X-ray.

2. The X-ray inspection device according to claim 1,
wherein the arithmetic device sets the threshold in accordance with an irradiation angle of the X-ray.

3. The X-ray inspection device according to claim 1,
wherein the arithmetic device detects a portion having a peak that is equal to or larger than the threshold as a defect.

4. The X-ray inspection device according to claim 3, further comprising a memory medium that stores a plurality of criterial luminance reference data pieces for each of different visual field positions of the transmission X-ray,
wherein the arithmetic device detects the defect on the basis of comparison between the plurality of criterial luminance reference data pieces and luminance data obtained by means of the transmission X-ray.

5. The X-ray inspection device according to claim 4,
wherein the memory medium stores a plurality of peak luminance reference data pieces corresponding to voids of a plurality of sizes for each of the plurality of criterial luminance reference data pieces, and the arithmetic device detects the defect on the basis of comparison between peak luminance obtained by means of the transmission X-ray and the plurality of peak luminance reference data pieces.

6. The X-ray inspection device according to claim 4,
wherein the arithmetic device detects the defect on the basis of a threshold registered for each of the plurality of criterial luminance reference data pieces.

7. A defect detection method in which a luminance profile is formed on the basis of the detection of a transmission X-ray which has been emitted from an X-ray source and passed through a sample, and a defect included in the sample is detected using the luminance profile, the defect detection method comprising the steps of:
setting a threshold corresponding to a visual field position of the transmission X-ray; and
detecting a portion having a peak that is equal to or larger than the threshold as a defect.
